(19) United States
(12) Patent Application Publication
(10) Pub. No.: US 2024/0004259 A1
(43) Pub. Date: Jan. 4, 2024

(54) MACH-ZEHNDER INTERFEROMETER INTEGRATED WITH MEMRISTOR

(71) Applicant: HEWLETT PACKARD ENTERPRISE DEVELOPMENT LP, Houston, TX (US)

(72) Inventors: Bassem Tossoun, Santa Barbara, CA (US); Stanley Cheung, Milpitas, CA (US)

(21) Appl. No.: 17/855,690

(22) Filed: Jun. 30, 2022

(51) Int. Cl. G02F 1/225; G02F 1/21; G02F 1/025

(52) U.S. Cl. CPC G02F 1/2257; G02F 1/212; G02F 1/025

(57) ABSTRACT

A memristor-integrated Mach-Zehnder Interferometer (MZI) device is implemented having the capability to function as a new type of photonic device that can be further leveraged to implement a wide-range of photonic applications, such as photonic chips, PICs, optical FPGAs, and the like. The memristor-integrated MZI device distinctly incorporates the photonic capabilities of an MZI with the resistive memory capabilities of a memristor, in order to create a photonic device that supports optical/photonic functions on a component-level. For example, MZI circuitry can include two waveguides coupled to an output terminal, wherein the MZI circuitry produces an optical signal as output and propagates the output optical signal to the optical terminal; and a memristor integrated on one or the two waveguides of the MZI circuitry, wherein the memristor receives an electrical signal as input and causes a phase shift in the output optical signal from the MZI circuitry.

### BACKGROUND

Interferometers are commonly used optical instruments having very high precision that use optical interference to implement measurements on a microscopic scale (e.g., widths ranging from submicrometer to 100 μm, and spacings ranging from less than 1 μm up to 1025 mm). Typically, in operation, interferometers split a beam from a light source, such as a laser, into two components: a reference beam; and a sensing beam. The reference beam will travel unaltered through an optical path. The sensing beam travels through a different optical path, where the light is affected by a change in the optical path that is caused by a characteristic that is intended to be measured (e.g., temperature, pressure, gases). The light beams (traveling through the separate paths) are then recombined in the interferometer, and the interference of the two beams will create an interference pattern, which can be measured and analyzed. An interference pattern between two light beams is generated by interferometers contain measurable information about the object and/or characteristic being studied.

A Mach-Zehnder Interferometer (MZI) is a particular type of interferometer device that is used to determine the relative phase shift variations between two collimated beams. IN particular, MZIs are structured using two beam splitters (as opposed to one), and thusly generates two output beams that can be analyzed separately. MZIs are wide-spread in scientific applications, being used in fields of aerodynamics and fluid dynamics—the fields in which the MZI was originally developed, plasma physics, and heat transfer to measure pressure, density, and temperature changes in gases.

### BRIEF DESCRIPTION OF THE DRAWINGS

The present disclosure, in accordance with one or more various implementations, is described in detail with reference to the following figures. The drawings are provided for purposes of illustration only and merely depict typical or example implementations. These drawings are provided to facilitate the reader's understanding of various implementations and shall not be considered limiting of the breadth, scope, or applicability of the present disclosure. It should be noted that for clarity and ease of illustration these drawings are not necessarily made to scale.

FIG. 1 depicts an example configuration of a fabricated memristor-integrated Mach-Zehnder Interferometer (MZI) device, in accordance with the disclosure.

FIG. 2 depicts a three-dimensional (3-D) schematic of a layer stack of materials to fabricate the memristor utilized in the memristor-integrated MZI device shown in FIG. 1, in accordance with the disclosure.

FIG. 3A depicts a microscopic cross-sectional image of the layer stack of materials shown in FIG. 2 to fabricate the memristor utilized in the memristor-integrated MZI device, in accordance with the disclosure.

FIG. 3B depicts an atomic resolution image of a bonding oxide interface formed by the layer stack of materials shown in FIG. 2 to fabricate the memristor utilized in the memristor-integrated MZI device, in accordance with the disclosure.

FIG. 4A depicts a graph including an IV curve representing switching characteristics of a memristor (e.g., unipolar mode) utilized in the memristor-integrated MZI device, in accordance with the disclosure.

FIG. 4B depicts a graph including an IV curve representing switching characteristics of a memristor (e.g., bipolar mode) utilized in the memristor-integrated MZI device, in accordance with the disclosure.

FIG. 5A depicts a graph including a measured current-voltage IV curve representing operation of a memristor utilized in the memristor-integrated MZI device, in accordance with the disclosure.

FIG. 5B depicts a graph including a curve representing the optical response of the memristor-integrated MZI device, where the memristor is being set, in accordance with the disclosure.

FIG. 5C depicts a graph including a curve representing the optical response of the memristor-integrated MZI device, where the memristor is in a set state, in accordance with the disclosure.

FIG. 5D depicts a graph including a curve representing the optical response of the memristor-integrated MZI device, where the memristor is being reset, in accordance with the disclosure.

FIG. 5E depicts a graph including a curve representing the optical response of the memristor-integrated MZI device, after the memristor has been reset, in accordance with the disclosure.

FIG. 6 illustrates an example computer system including a programmable photonic Field Programmable Gate Array (FPGA) implemented using the memristor-integrated MZI device shown in FIG. 1, in accordance with the disclosure.

FIG. 7 depicts a block diagram of an example computer system in which various of the implementations described herein may be implemented.

The figures are not intended to be exhaustive or to limit various implementations to the precise form disclosed. It should be understood that various implementations can be practiced with modification and alteration.

### DETAILED DESCRIPTION

Photonics is an area of study that involves the use of radiant energy (such as light), whose fundamental element is the photon. Generally, photonic applications use the principles of optics to manipulate a photon in the same way that electronic applications use the electron. Photonic devices that run on light have a number of advantages over devices that use electricity. For instance, light travels at about 10 times the speed of electricity, which means that data transmitted photonically can travel long distances in a fraction of the time than data transmitted via electrical signals. Consequently, the growth of photonics in computing has realized a wide-range of advantages such as high-speed, high-bandwidth, and high-efficiency over the conventional use of electrical devices.

In current computer architectures, which primarily employ electrical components/devices, the von Neumann bottleneck (e.g., latency associated with transferring data between memory and processor in a computer) limits the bandwidth with respect to electrical interconnects between memory and CPU. Additionally, there are multiple other drawbacks and/or limitations experienced in current computer architectures that are associated with silicon integrated circuits (ICs) driven primarily by electrical components/devices, such as complementary metal-oxide semiconductor (CMOS) chips. For example, the amount of power consumption associated with silicon ICs continues to increase due to the use of conventional electrical components/devices, such as heat-dissipation associated with metal interconnects and leakage current associated with transistors.

In order to solve these and other issues associated with tradition CMOS technology (relying on electrical devices/components), silicon photonics has emerged as a technology that leverages the wealth of advantages that photonics has over conventional electrical-based CMOS devices/components to provide enhanced high-bandwidth, energy-efficient optical-based devices and/or systems, such as optical interconnects (as opposed to electrical interconnects). For example, silicon photonics is becoming increasingly used to implement and optimize high-performance computers (HPCs), an area where increased bandwidth and efficiency are essential to meet the high processing demands.

Further, a rise in demand for silicon photonics has led to an emergence of devices that can be leveraged to support photonics on the component-level, also reference to as photonic devices. By increasing the number of available photonic devices, it may be possible for a greater number of silicon photonics applications to be realized. Examples of photonic applications that are gaining in popularity that may also benefit from photonic devices include: photonic chips; photonic integrated circuits (PICs); optical field-programmable gate arrays (FPGAs); photonic platforms; photonic networks; and photonic computers (also referred to as an “all-optical” computers). Memristors are a type of device having a structure and functionality that lends itself for implementation of photonic devices and further for silicon photonics. For example, memristors have resistive switching and memory capabilities that can potentially provide an alternative to electrical devices that are traditionally employed in computer architectures, such as volatile flash memory. By extending the use of optics/phonics to photonic devices, silicon photonics, and beyond, the possibility of new computing architectures, such as in-memory computing, are on the horizon. In-memory computing is a concept that is currently heavily pursued for advancing computer technology. Integrating these photonic-based applications and technologies together can further shorten the bridge between the CPU and memory (relating to the von Neumann bottleneck) and ultimately realize enhanced energy-efficient, high-speed, memory-driven, photonic-based computers.

In accordance with the disclosed embodiments, a memristor-integrated Mach-Zehnder Interferometer (MZI) device is designed as a new type of photonic device that can be further leveraged to implement a wide-range of photonic applications, such as photonic chips, PICs, optical FPGAs, and the like. As will be described herein, the memristor-integrated MZI device distinctly incorporates the photonic capabilities of an MZI with the resistive memory capabilities of a memristor, in order to create a photonic device that supports optical/photonic functions on a component-level. In particular, the disclosed memristor-integrated MZI is a photonic device that can function as an optical interconnect component, an optical switch component, and an optical memory component.

In an embodiment, the memristor-integrated MZI device, disclosed herein, is a photonic device functioning as an optical interconnect. By employing the memristor-integrated MZI device as an optical interconnect, for example between a memory chip and a processor/CPU chip of a computer, allows optical-to-electrical (and/or electrical-to-optical) conversions to be bypassed. In contrast, some current computer architectures that utilize traditional electrical (metal) interconnects, require many optical-to-electrical conversions in order to support the data transfer that occurs between the computer's CPU (e.g., implemented on PIC) and its memory chip (e.g., implemented on a CMOS chip). Therefore, the disclosed memristor-integrated MZI device provides optical interconnect capabilities that realize several advantages, such as reduce latency and higher bandwidth with respect to interconnect components.

In an embodiment, the memristor-integrated MZI device, disclosed herein, is a photonic device functioning as an optical switch and/or an optical memory component. By employing the memristor-integrated MZI device as an optical memory component, energy-efficiency and speed of the computer can be improved. Furthermore, the optical memory capabilities of the memristor-integrated MZI device may be used to continue progress towards optical data storage in specific applications, such as optoelectronic content-addressable-memory (CAM) and random-access-memory (RAM).

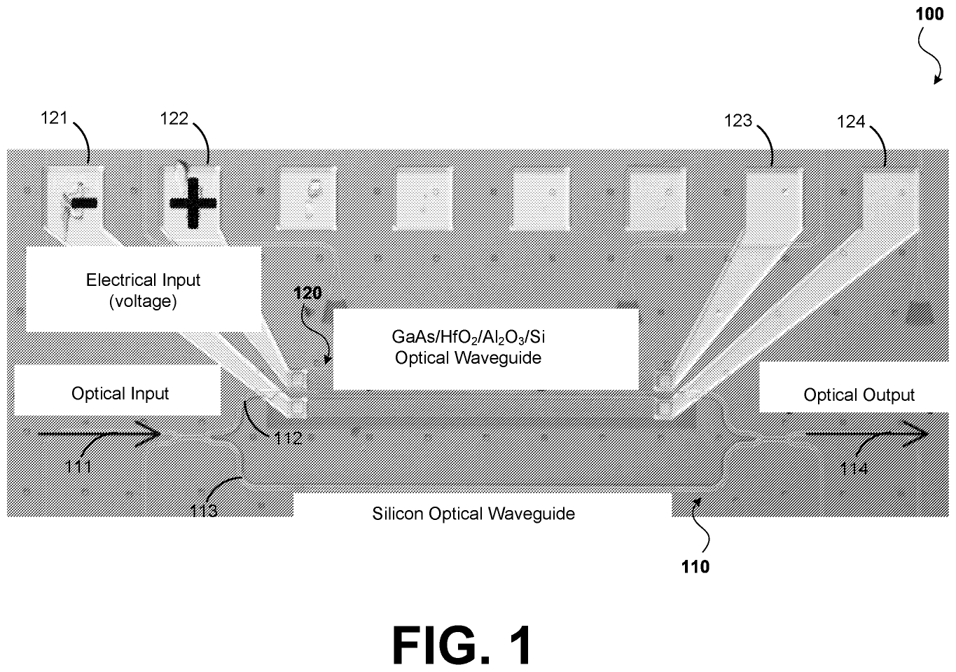

FIG. 1 depicts an example physical structure for implementing a memristor-integrated MZI device 100, in accordance with the disclosed embodiments. For example, FIG. 1 illustrates an example of a fabricated memristor-integrated MZI device 100. As seen in FIG. 1, the memristor-integrated MZI device 100 comprises several components, including: an input terminal 111; a first silicon waveguide 112 (also referred to as an upper waveguide) having a memristor 120 integrated thereon; a second silicon waveguide 113 (also referred to as a lower waveguide); electrodes 121, 122 (n electrode) and 123, 124 (p electrodes); and output terminal 114. Additionally, FIG. 1 illustrates that at a high-level, the architecture of the memristor-integrated MZI device 100 includes an MZI 110 structure, and an memristor 120 structure integrated on silicon. Generally, the operation of the memristor-integrated MZI device 100 can be described as a photonic device, which receives an electrical signal as input to change the state of the memristor 120, where the memristor 120 functions to store data (using resistive memory capabilities) and produces an optical signal as output using the MZI 110, wherein the MZI 110 functions to enable optical reading of the stored data from the memristor 120. Although the memristor-integrated MZI device 100 is described in reference to the example configuration depicted in FIG. 1 with the memristor 120 integrated on the upper silicon waveguide 112, this arrangement is not intended to be limiting as the memristor 120 can also be integrated on the lower silicon waveguide 113 of the MZI 110 structure (without substantively altering the functionality and/or operation of the memristor-integrated MZI device 100).

Memristors, such as memristor 120, can be described as a resistive switching device. A memristor can be driven (or programmed) to multiple different resistive states by applying an electrical signal, for example a voltage or current pulse. The electrical signal generates a combination of electric field and thermal effects that modulate the conductivity/resistivity in a manner that implements a type of non-volatile memory capability and/or a switch capability. After programming, the state of the memristor remains stable over a time period, and then the state is thus readable. Accordingly, memristors have been used as components in a wide range of electronic circuits, such as memories, switches, radio frequency circuits, and logic circuits and systems. In accordance with the embodiments, memristors are utilized as a form of memory device. When used as a basis for memory devices, changing the state of the memristors may be used to store information (e.g., bits of 1 or 0).

In accordance with the disclosed embodiments, the memristor-integrated MZI device 100 can be fabricated on silicon, such as a silicon substrate. For example, the memristor-integrated MZI device 100 is structured on a Silicon-On-Insulator (SOI) wafer that can be made with a buried oxide (BOX) substrate and a top silicon layer. Accordingly, the optical waveguides of the device 100 that are illustrated in FIG. 1, including optical waveguides 112, 113 can be implemented as silicon waveguides. As an example, the silicon layer of SOI wafer, on which the device 100 is fabricated, can be patterned to create the device's 100 waveguides, namely optical waveguides 112, 113.

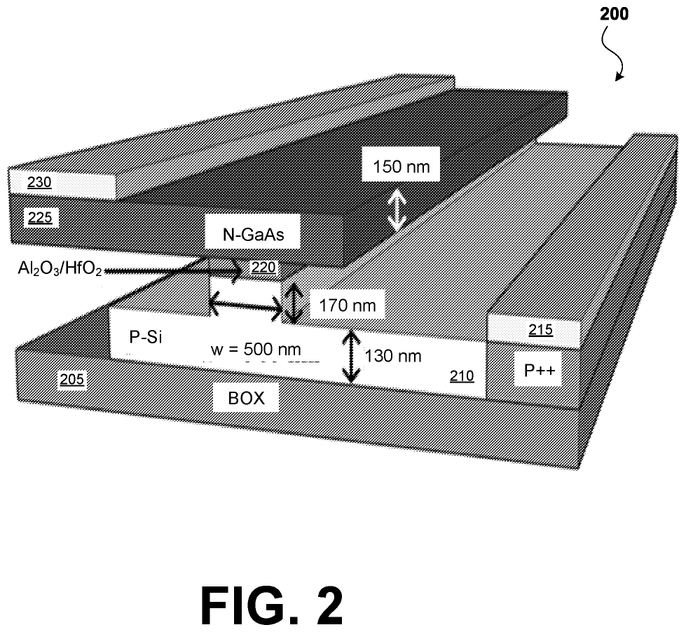

Additionally, FIG. 1 depicts that the memristor 120 is a device that is particularly structured using a III-V material and an oxide/dielectric material that are formed on top of the silicon layer. In the example of FIG. 1, the materials that are depicted in the fabricated memristor include Gallium arsenide (GaAs) as the III-V material and aluminum oxide (Al₂O₃)/Hafnium oxide (HfO₂) as the oxide/dielectric material that are layered on top of silicon (Si). Constructing the memristor 120 can include a specialized process that involves wafer bonding the III-V material to the silicon, having a thin layer of the oxide/dielectric material sandwich in between, in a manner that creates a hybrid semiconductor-insulator-semiconductor capacitor (SISCAP) and the memristor 120 simultaneously. Details regarding the materials and the specialized wafer bonding process that are utilized to fabricate the disclosed memristor-integrated MZI device 100 are described in reference to FIG. 2. Further, it should be appreciated that the materials depicted in FIG. 1 are merely examples that are shown for purposes of illustration and are not intended to be limiting. Accordingly, the memristor-integrated MZI device 100 can be constructed using other III-V semiconductor materials, oxide/dielectric materials, active materials, and other materials that are not shown in FIG. 1, as deemed necessary and/or appropriate.

The MZI-based function of the memristor-integrated MZI device 100 is based on light traveling in transmission through waveguides, starting from entry into the device 100 at the input terminal 111 For example, a light source, such as an optical laser that is proximate and/or optically coupled to the input terminal 111 of the memristor-integrated MZI device 100 can generate light that enters the device 100 (via the input terminal 111) as an optical input. The input terminal 111 can be implemented as a bus waveguide coupled to the MZI 110.

Once light moves from the input terminal 111, that light is split into two separate light beams within the memristor-integrated MZI device 100. Accordingly, each light beam continues along a separate optical path on a respective branch of the device's 100 two arms, shown as an upper arm and a lower arm in FIG. 1. An upper arm of the MZI is implemented by an upper (e.g., first) silicon waveguide 112, and the lower arm of the MZI is implemented by the lower (e.g., second) silicon waveguide 113. Thus, after the light of the optical input is split, one light beam can travel along an optical path routed on the upper arm of the MZI 110, thereby traversing the upper silicon waveguide 112, and the other light beam can travel along a different optical path routed on the lower arm of the MZI 110, thereby traversing the lower silicon waveguide 113. The memristor-integrated MZI device 100 can include a beamsplitter (not shown) to split the light from the optical input into the two separate beams, or the input light can naturally separate, where the light forks in order to travel along both optical paths that are formed by optical waveguides 112, 113 (or both arms of the MZI 110) based on the propagation properties of light (without a splitting mechanism). As an example, light travelling along a single optical waveguide (depicted in FIG. 1 to the right of the device 100 between the input terminal 111 and the two arms of MZI 110), can split into light traveling in two separate directions/routes as the single optical waveguide branches off, or splits, into the two separate optical waveguides 112, 113. The upper arm of the MZI 110, including the optical waveguide 112 and the integrated memristor 120 can be also be referred as a “memristor-branch” of the MZI 110. Although a beamsplitter is described for purposes of illustration, other types of beam splitting mechanisms can be used to implement the MZI 110 of the memristor-integrated MZI device 100, such as a multimode interferometer (MMI), 1×2 power splitter, or directional coupler.

The light beam traversing the memristor-branch of the MZI 100, which is the optical path along the first waveguide 112 having the memristor 120 integrated thereon, has properties that are impacted by the non-linearity and capacitive/conductive characteristics of the memristor 120. In operation, an electrical signal input (e.g., voltage, current) is applied across the electrodes 121, 122, positioned on top the memristor 120 on the memristor-branch of the memristor-integrated MZI device 100. This electrical signal input causes the memristor 120 to experience an electrically driven change in its state, and the electrically driven state change of the memristor 120, in turn, affects the light propagating along the optical path on the upper arm of the MZI 100, and particularly through upper waveguide 112 (or the memristor-branch of the MZI 100). Consequently, as light moves in the optical waveguide 112, or the upper arm of the MZI 110 while the memristor 120 is operatively enabled, this light experiences a non-linear phase shift that is induced by the presence (and characteristics) of the memristor 120 on that optical path.

In contrast, the light beam that is traversing the lower arm of the MZI 110, and propagating along optical waveguide 113, travels unaltered through that optical path. Therefore, the light beam this moving through the memristor-integrated MZI device 100 along the upper arm is experiencing a phase-shift, due to the memristor 120, that is not experienced by the light beam that in moving through the memristor-integrated MZI device 100 along the lower arm (not having an integrated memristor). The phase-shifted light, moving past the portion of the upper arm that includes the memristor 120, continues to propagate through the optical waveguide 112. Ultimately, the phase-shifted light traverses the entire length of the upper arm of the MZI 110 in order to arrive at the output terminal 112. Similarly, the unaltered light continues to propagate though the optical waveguide 112, and traverses the entire length of the lower arm of the MZI 110. Prior to the reaching output terminal 114, the phase-shifted light beam that is routed through the upper arm of the MZI 110, via optical waveguide 112, is coupled/combined with the unaltered light beam that is routed though the lower arm of the MZI 110, via optical waveguide 113. The output terminal 114 can be implemented as a bus waveguide coupled to the MZI 110.

As seen in FIG. 1, the overall optical path through the memristor-integrated MZI device 100 can be generally described as: (on the right side of the device 100) the optical path from the input terminal 111 splitting into two separate optical paths that branch out and are routed along a respective arm of the MZI's 110 structure, namely the upper arm and the lower arm of the MZI 110; and (on the left side of the device 100) the two arms of the MZI's 110 structure end, where these two separate and branched out optical paths converge, and the two routes come back together to form a single optical path that leads to the optical output terminal 114. The portion of the device's 100 optical path where the two arms appear to end, and the two separate optical waveguides 112, 113 converge into a single optical waveguide (or optical path) can be considered the area of the device 100 where the respective light beams are coupled/combined. The memristor-integrated MZI device 100 is structured to re-combine the two separate light beams (respectively corresponding to the optical waveguide 112 on the upper arm of the MZI 110, and the optical waveguide 113 on the lower arm of the MZI 110) into a single light beam that serves as the optical output of the memristor-integrated MZI device 100. After the coupling point, the combined light beam propagates the remaining portions of the optical waveguide (e.g., to the left of the termination of the upper arm and lower arm of the MZI's 110 structure) and exits, or can be measured/sensed, at the output terminal 114. The memristor-integrated MZI device 100 can include a beamsplitter/coupler (not shown) to combine the two separate light beams, respectively corresponding to optical waveguides 112, 113 into a single light beam that serves as the optical output of the memristor-integrated MZI device 100. In an embodiment, light can naturally combine, where the separate light beams come together from the separate optical waveguides 112, 113 in order to travel along the same converged optical path that is formed by a single optical waveguide (after the upper arm and lower arm of the MZI's 110 structure terminate) based on the propagation properties of light (without a splitting mechanism). For instance, the two separate light beams correspondingly travelling along the two separate optical waveguides 112, 113 on the two branched arms of the MZI 110, can be re-combined into light traveling on the same optical path, as the previously split optical paths along optical waveguides 112, 113 are merged into a single optical path that is routed along a single optical waveguide that feeds into the output terminal 114.

In operation, by applying an electrical input (via the electrodes 121, 122, 140, 145) to the memristor 120, the memristor 120 is electrically-driven to switch to one of its multiple different resistive states. Each of the different states of a memristor may be indicative of data. Thus, a predefined switching voltage being applied across the memristor 120, drives the memristor 120 to a predefined state that corresponds to a particular data value. As the memristor 120 retains that state over a period of time, the memristor 120 effectively stores that corresponding data value. For example, the memristor 120 can be set to a low resistive state to represent a binary ‘1’ by applying the switching voltage, or can be set to a high resistive state to represent a binary ‘0’ by applying another voltage, for example, another switching voltage in the opposite polarity. Furthermore, this switch in the memristor's 120 state causes a shift in the optical response of the MZI 110. In other words, the MZI 110 will change/shift the wavelength of its optical output (e.g., the light propagating out of the MZI 110 towards output terminal 114) according to the current level/state of the memristor 120. For example, applying a predefined voltage to the memristor 120 can effectuate a corresponding predefined shift, or increase in the wavelength, of the light that is optically output from the MZI 110. In this manner, a predefined voltage can correspond to data, a predefined state for the memristor 120, and a predefined shift in the optical response. Accordingly, measuring the phase shift of the optical output from the memristor-integrated device 100, resulting from the applied voltage (and state of the memristor 120) functions as a means to optically read the data that is stored in the memristor 120 (e.g., represented by the memristor's 120 retained resistive state). Therefore, the memristor-integrated MZI device 100 can be used to electrically write and store data by switching its state (e.g., switching the conductivity/resistivity of the memristor's 120 oxide layer), and then the data can be optically read by measuring the phase shift (e.g., optical power) of the light output by the memristor-integrated MZI device 100 at the output terminal 114. This functionality enables the optical switching, optical memory, and optical interconnect capabilities of the memristor-integrated MZI device 100, as described herein.

FIG. 2 is a schematic that depicts an example structure for a memristor 200 that can be integrated with an MZI, implementing the disclosed memristor-integrated MZI device (shown in FIG. 1). The memristor 200 is a device that retains its electrical state, which can be manipulated, as disclosed herein, to provide electrically driven memory capabilities. The example of FIG. 2 illustrates several layers 205-230 of materials, such as III-V semiconductor material, an oxide material, and silicon materials that can be used to structure the memristor 200. As a general description, consists of an oxide material sandwiched in between two conductive materials. Particularly, FIG. 2 illustrates that the memristor 200 is formed by a stack of several layers of materials, which include (from bottom to top): a buried oxide (BOX) layer 205; a silicon (e.g., p-type doped Si material) layer 210; an oxide layer (e.g., Al₂O₃/HfO₂ material) layer 220; a III-V layer (e.g., GaAs material) 225; and electrode (e.g., metal materials) layers 215, 230. Generally, the memristor 200 is created by depositing a thin oxide layer 220 of oxide/dielectric material between the conductive materials contained in the III-V layer 225 and the silicon layer 210. As alluded to above, a process to fabricate photonic devices which includes specialized wafer bonding and layering of certain materials can be utilized to form the memristor 200.

In one example, the memristor 200 is fabricated on a SOI wafer, where the SOI wafer comprises any suitable configuration of silicon materials and insulator materials. The SOI wafer can include a layer of silicon that is separated from the bulk substrate by a thin layer of insulator and made using existing semiconductor fabrication techniques. For example, the SOI wafer can include a bulk silicon carrier substrate layer as the bottom-most layer of the wafer, or the underlying substrate layer, upon which the other layers (or the upper layers 205-230) of the memristor 200 are formed thereon.

FIG. 2 shows a buried oxide (BOX) layer 205, as the substrate or the bottom-most layer of the memristor's 200 structure. The BOX layer 205 can comprise silicon oxide (SiO₂) material that is buried in the bottom-most layer of the SOI substrate. The BOX 220 serves as the insulator and provides optical confinement for the upper layers 210-230 of the memristor 200, and other PICs that may be etched on the SOI wafer.

A silicon layer 210 is adjacent to the BOX layer 205. The silicon layer 210 can comprise a film of Si material. For example, a photonic platform can start with the SOI wafer that can be made with BOX layer 205 and a top silicon layer 210. Thus, the silicon layer 210 forming the memristor 200 can be considered as a portion of a larger silicon layer 210 of the entire SOI wafer. The silicon layer 210 of the SOI wafer can be etched in patterns to create passive waveguides (having a level of optical waveguide confinement), which in the disclosed embodiments can serve as the waveguides of the MZI structure (shown in FIG. 1). Restated, the MZI is formed (e.g., as a passive waveguide circuit of a PIC) by the etched silicon in the silicon layer 210 of the SOI wafer. With respect to the memristor 200 structure, the silicon layer 210 also includes silicon material used for bonding the III-V material to SOI wafer in order to construct the memristor 200. This shared silicon layer 210, where the silicon is used to form both the memristor 200 and the MZI structure, allows the memristor 200 to be integrated within the MZI on the single SOI wafer, in a manner that enables distinct optoelectronic capabilities and efficiency (e.g., small footprint). FIG. 2 also depicts that the silicon layer 210 is doped to create a section of p-type (P++) silicon.

A III-V layer 225 can be wafer bonded on top of the silicon layer 210. The III-V layer 225 can be implemented as a III-V epitaxial layer comprising a III-V semiconductor material (e.g., In—P based compound semiconductors). In the example of FIG. 2, the III-V layer 225 comprises GaAs as the III-V semiconductor material. Although GaAs is depicted in FIG. 2, it should be appreciated that other types of III-V semiconductor materials can comprise the III-V layer 225. Also, FIG. 2 depicts that the III-V layer 210 is doped to create an n-type GaAs semiconductor material (n-GaAs).

As previously described, in order to construct the memristor 200, a specialized wafer bonder process is employed which adheres the III-V layer 225 to the silicon layer 210 thereby bonding the III-V semiconductor material to the top layer of silicon of the SOI wafer. This wafer bonding process is distinct/specialized, because during the bonding of the III-V layer 225 to the silicon layer 210, an oxide layer 210 is deposited in between these layers 225, 210 as an adhesive that bonds the III-V semiconductor material and the Si material together in the respective layers 225, 210. The oxide layer 220 can comprise a thin film of an oxide/dielectric material, shown as Al₂O₃/HfO₂. Although Al₂O₃/HfO₂ is depicted in FIG. 2, it should be appreciated that other types of oxide/dielectric materials can selectively comprise the oxide layer 225 based on the properties of the respective material that are most optimal for the design/application goals. For example, types of oxide/dielectric material properties that may be considered for selectively forming the oxide layer 220 can include, but are not limited to: bonding strength and/or adhesiveness properties; capacitance properties; K dielectric properties; ionization properties; resistive switching properties; speed properties; durableness and/or high endurance properties; optical properties; and the like. Therefore, an oxide/dielectric material that is sufficient in one or more of the aforementioned properties, but deficient in other properties, may still be desirable for the oxide layer 220 based on the design trade-offs and the design/application goals. For example, an oxide/dielectric material that has lower bonding strength but a higher K dielectric property may be suitable for the oxide layer 220 where the particular application necessitates increase gate capacitance without the associated leakage effects. Examples of oxide/dielectric materials that may be selected for forming the oxide layer 220 can include, but are not limited to: Si; silicon oxide (SiO₂); silicon nitride (Si₃N₄); aluminum oxide (Al₂O₃); tantalum pentoxide (Ta₂O₅); titanium dioxide (TiO₂); strontium titanate (SrTiO₃); zirconium dioxide (ZrO₂); hafnium oxide (HfO₂); hafnium silicate (HfSiO₄); lanthanum oxide (La₂O₃); yttrium oxide (Y₂O₃); and lanthanum aluminate (LaAlO₃).

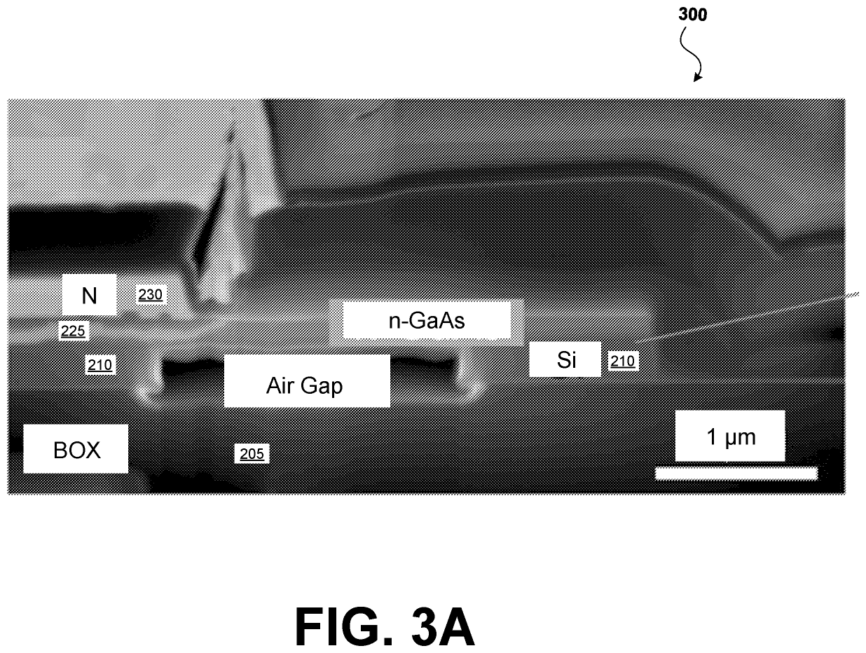

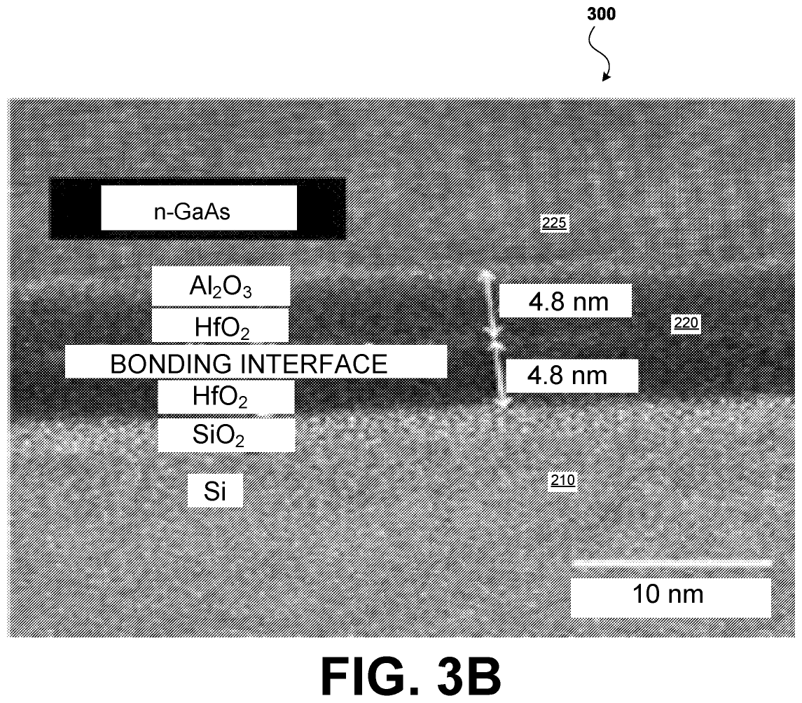

In the specialized wafer bonding process, the oxide layer 220 is deposited before the III-V layer 225 physically contacts the silicon layer 210. Thus, once these layers 225, 210 have been contacted, areas of direct contact between the III-V layer 225 and the silicon layer 210, referred to as a bonding oxide interface, form a hybrid capacitor which enables the resistive switching functionally for the memristor 200. Thus, the capacitor created wafer bonding the III-V layer 225 to the silicon layer 210, via the oxide/dielectric material in oxide layer 220, is simultaneously, in essence, the memristor 200. FIG. 3B depicts an atomic resolution image (e.g., transmission-electron microscope (TEM) image) of this bonding oxide interface. FIG. 3B illustrates that a bonding oxide interface is formed by the thin layer of Al₂O₃/HfO₂ oxide/dielectric material contained in the oxide layer 220 that is deposited between the bonded III-V layer 225 of GaAs material and the silicon layer 210. This bonding oxide interface, in the oxide layer 220, serves as a gate oxide, which along with the Si layer 210 and III-V layer 225, form a semiconductor-insulator-semiconductor capacitor (SISCAP) and simultaneously, a memristor. In other words, once these III-V layer 225 and the silicon layer 210 have been contacted during wafer bonding, the areas of direct contact, namely the bonding oxide interface including the oxide/dielectric material, form a MOS/SISCAP capacitor component, which effectively is the memristor. Although constructing the memristor 200 with the III-V layer 225 and oxide layer 200 using the specialized wafer bonding process is described herein, it is not intended to be limiting as it is possible to construct the memristor 200 using other forms of active materials that would not involve wafer bonding without substantively departing from the scope of the invention. Types of materials that can be used in this embodiment can include, but are not limited to: lithium niobate (LiNbO₃), barium titanate (BaTiO₃), and indium tin oxide (ITO).

Referring back to FIG. 2, the upper-most layers of the memristor 200 are shown as electrode layers 215, 230. As seen, electrode layer 215 comprises a p-type electrode that is formed on top of p-type Si material of the silicon layer 210, and the electrode layer 230 comprises a n-type electrode that is formed on top of the n-type GaAs material of the III-V layer 225. The electrode layers 215, 230 serve as contacts to apply an electrical field across the gate oxide (of the SISCAP) created by the wafer bonded III-V layer 225, oxide layer 220, and silicon layer 210. Further, when the memristor 200 is operating in a lower resistance state, it may contribute to a change of effective index of refraction by localized Joule heating within conductive filaments (CFs) inside of the memristor. As a result, in operation, the refractive index and free-carrier absorption loss in the GaAs material in the III-V layer 225 and silicon material in the silicon layer 210 change as a result of free carriers accumulating or depleting near the gate oxide (formed in the oxide layer 220) under an external bias, thereby implementing the electrically driven state-changing functionality of the memristor 200.

By implementing the disclosed memristor-integrated MZI device as a silicon-based device, the device itself and its photonic functions can be realized on a silicon photonic platform that integrates multiple other photonic devices and functions. In an example, one or more memristor-integrated MZI devices can be implemented on a silicon photonic platform, where the devices function as optical interconnects to several programmable PICs that also share the silicon photonic platform. Therefore, photonic devices, programmable PICs, and the memristor-integrated MZI devices, which are all implemented on the silicon photonic platform, can operate collectively to realize larger-scale silicon photonic applications, such as optical Field-Programmable Gate Array (FPGA) and photonic chips. Moreover, as advancements in silicon photonics continue to progress the processing, memory, and interconnect (i.e., memristor-integrated MZI device shown in FIG. 1) functions for a computer may all be implemented as photonic devices on the same photonic platform in a manner that can eventually realize an “all optical” computer. A well-known principle in computing is the many advantages associated with replacing as many electrical-based elements (e.g., CMOS) in electronics with photonic/optical devices, thus an “all optical” computer may be considered as full optimization of speed, bandwidth, and energy-efficiency.

Also, FIG. 3A depicts an image of the fabricated memristor 200. Specifically, FIG. 3A is a scanning electron microscope (SEM) cross section image of the formed memristor 200 structure, where the BOX layer 205, silicon layer 210, III-V layer 225; and electrode layer 230 of the memristor 200 (described in detail above in reference to FIG. 2) are visible.

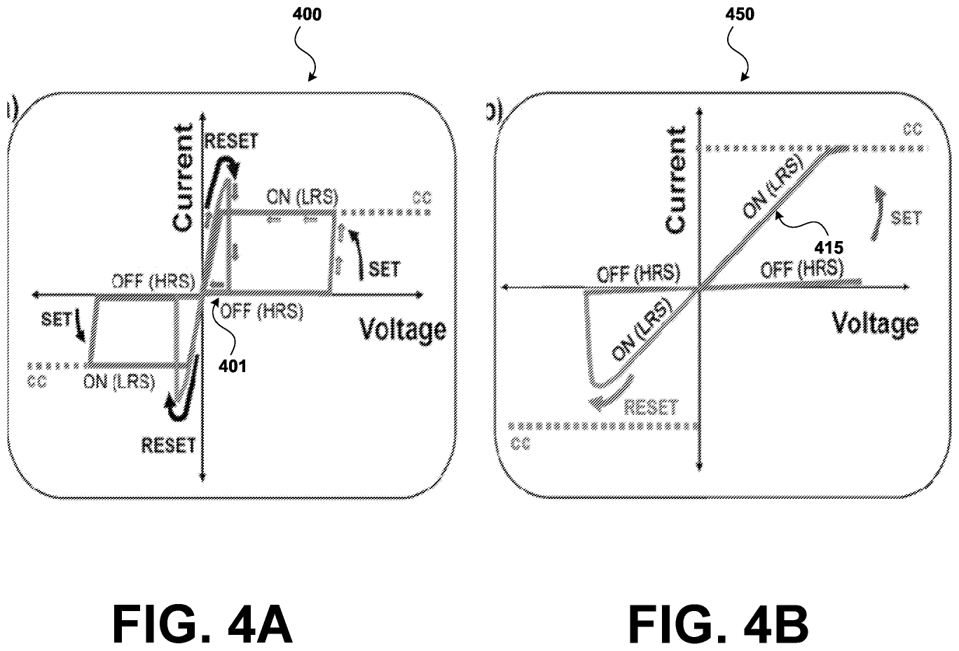

FIG. 4A depicts a graph 400 including a curve 401 representing the switching characteristics of a memristor, for example the memristor of the disclosed memristor-integrated MZI device, operating in a unipolar mode. As background, a memristor is a passive component in which there is functional relationship between electric charge and magnetic flux linkage. When current flows in one direction through the memristor, electrical resistance increases, whereas when current flows in the opposite direction, resistance decreases. When current is stopped, the component retains the last resistance that it had, and when the flow of charge begins again, the resistance of the memristor will be what it was when it was last active. A memristor has an operational regime with an approximately linear charge-resistance relationship, so long as the time-integral of the current stays within certain bounds. Thus, a memristor can be driven, using an electrical signal, to a plurality of different states.

One of the characteristics of a memristor is depicted by the curve 401 seen in FIG. 4a, which can be described as a hysteresis-shaped IV curve. In particular, the curve 401 represents the characteristics of a unipolar memristor. When applying a high applied electric field across the memristor's oxide layer (shown in FIG. 2), electroforming occurs as a conductive path is created within the oxide layer. This electroforming causes the memristor to switch from a capacitor to a resistor. Afterward, when reading the current at low bias voltages, the current in the memristor is much higher than it was before. Then, when applying a high electric field in the opposite polarity, the conductive path previously created is ruptured, and the oxide once again acts like an insulator. Therefore, the current read at this state, is significantly lower than it is in the ON state.

FIG. 4B depicts a graph 440 including a curve 451 representing the switching characteristics of a memristor, for example the memristor of the disclosed memristor-integrated MZI device, operating in a bipolar mode. Restated, the curve 451 represents the characteristics of a bipolar memristor. The curve 451 illustrates the general bipolar behavior of a memristor. As a result of having bipolar switching, curve 415 depicts that the conductance of the memristor increases (or decreases) according to the polarity of the voltage. Curve 451 particularly illustrates that a forward polarity (e.g., positive) of the voltage causes the conductance of the memristor to increase (e.g., current increases); and conversely a reverse polarity (e.g., negative) of the voltage causes the conductance of the memristor to decrease (e.g., current decreases) and

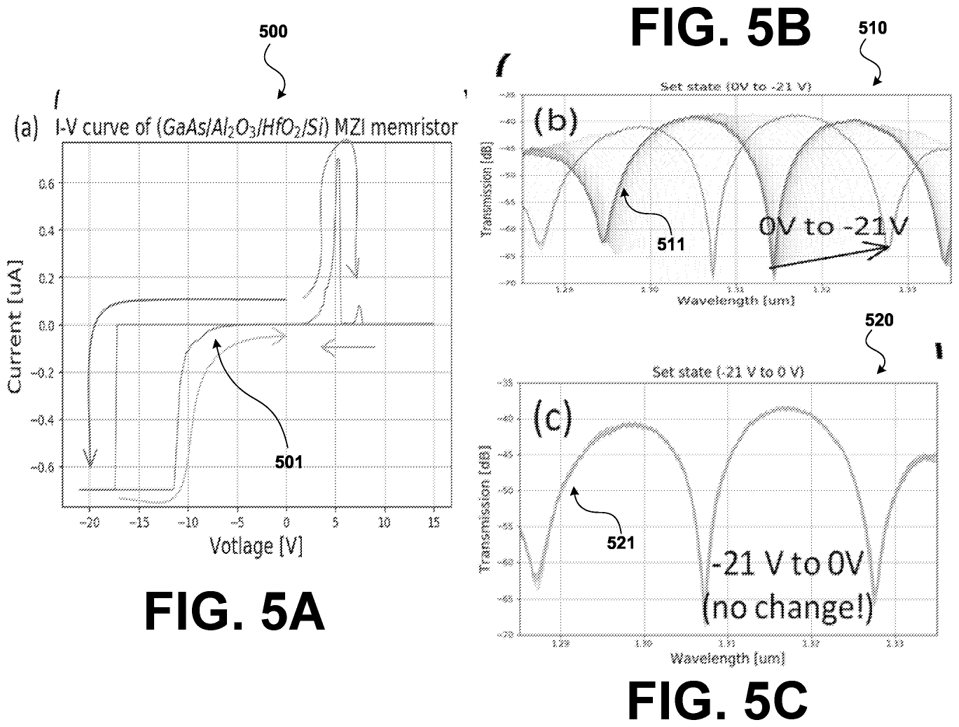

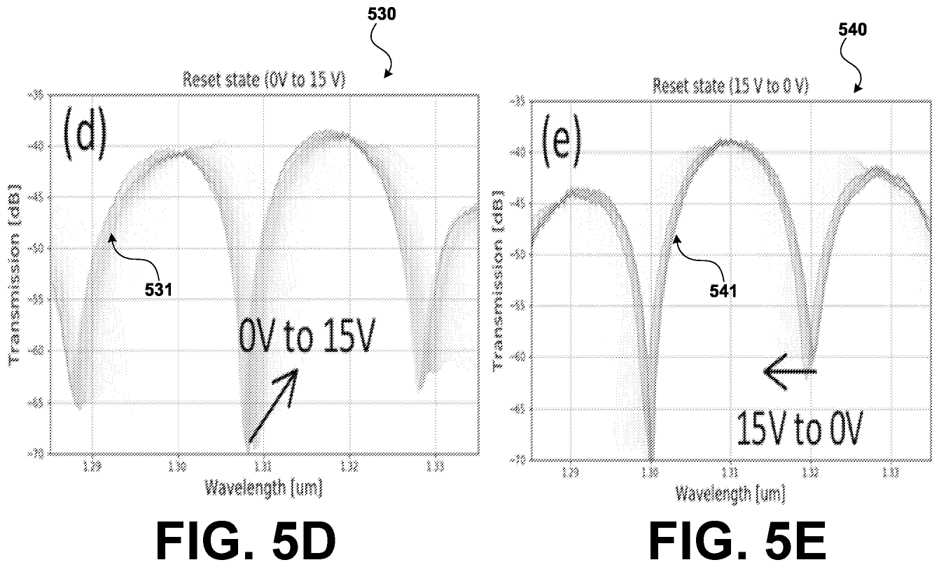

FIG. 5A depicts a graph 500 including a curve 501 representing a measured current-voltage (I-V) curve of a memristor, for example the memristor of the disclosed memristor-integrated MZI device. The voltage represented by I-V curve 501 depicts an example of the electrical input that may be input into the memristor-integrated MZI device. For example, I-V curve 501 illustrates that a low electrical input, or low bias voltages (e.g., approximately a range of 2.5 V to 5 V), can cause current readings from the memristor of the memristor-integrated MZI device to be generally higher (e.g., approximately 0.7 μA shown in FIG. 5A) than at higher voltages.

FIG. 5B depicts a graph 510 including a curve 511 representing an optical response of the memristor-integrated MZI device, or a relationship between the measured optical output (i.e., wavelength in μm) of the memristor-integrated MZI device and a set state (i.e., set states between 0 V to −21 V) of the device's memristor. Applying a positive voltage sweep results in a large 14 nm redshift in wavelength of the optical output as shown by curve 511 in FIG. 5A.

FIG. 5C depicts a graph 520 including a curve 521 representing optical response of the memristor-integrated MZI device, or a relationship between the measured optical output (i.e., wavelength in μm) of the memristor-integrated MZI device and a set state (i.e., set states between −21 V to 0 V) of the device's memristor. The curve 521 in FIG. 5B illustrates that ramping back to 0 V does not shift the optical response back to its original state, thus indicating a memory effect and a permanent change in the oxide layer material within the memristor. Essentially, the memristor can be manipulated to produce an optical response from the memristor-integrated MZI device that is shifted while consuming near zero continuous power.

FIG. 5D depicts a graph 530 including a curve 531 representing optical response of the memristor-integrated MZI device, or a relationship between the measured optical output (i.e., wavelength in μm) of the memristor-integrated MZI device and a reset state (i.e., set states between 0 V to 15 V) of the device's memristor.

FIG. 5E depicts a graph 540 including a curve 541 representing optical response of the memristor-integrated MZI device, or a relationship between the measured optical output (i.e., wavelength in μm) of the memristor-integrated MZI device and a reset state (i.e., set states between 15 V to 0 V) of the device's memristor.

The large wavelength shifts (e.g., 14 nm wavelength shifts), illustrated in FIGS. 5B-5E, that can be achieved by the distinct structure and function of the disclosed memristor-integrated MZI device is phenomena that has not previously reported, and is potentially a result of chemistry of the semiconductor/dielectric interface, which is achieved by the specialized wafer bonding process used to fabricate the memristor-integrated MZI device. That is, the oxygen transfer from the oxide/dielectric material (e.g., HfO2/Al2O3) into silicon potentially results in the aforementioned large wavelength shift in the device's optical output.

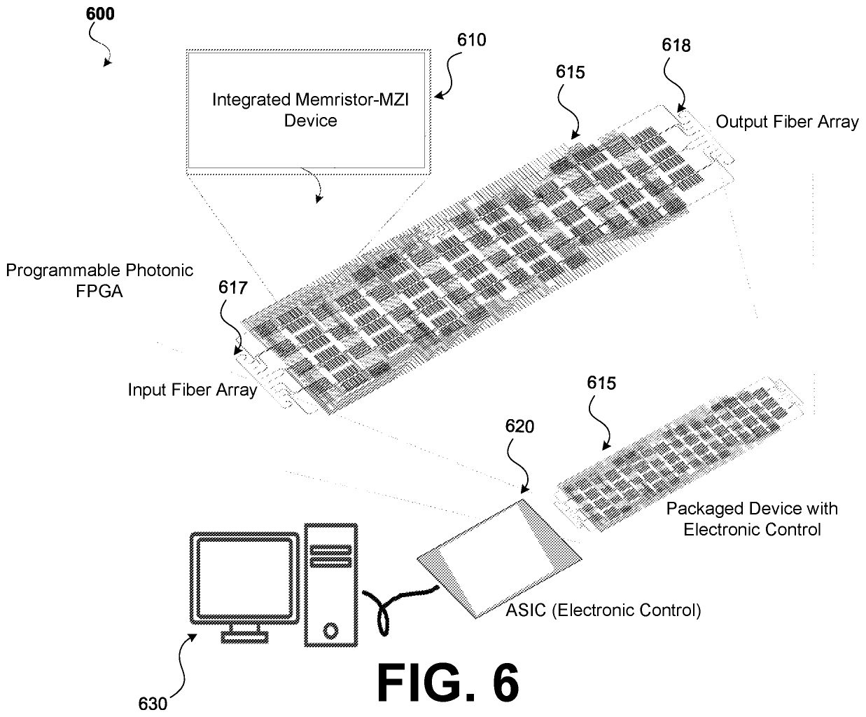

FIG. 6 depicts an example of a system 600 that employs the disclosed memristor-integrated MZI device to particularly implement a larger scale computing system application. In particular, FIG. 6 illustrates a computer device 630 having a hardware processor architecture that includes a programmable photonic FPGA 615, where the programmable photonic FPGA 615 is implemented using a plurality of memristor-integrated MZI devices 610, as disclosed herein. As a general description, the programmable photonic FPGA 615 is a photonic-based signal processor that can be re-programmed on demand (similar to an electronic FPGA-based signal processor). FPGAs are a critical building block in emerging computer technology, as FPGAs are ICs that are designed to be configured (and re-configured) by a customer (e.g., designer) after manufacture. FPGAs can be leveraged in a wide range of data processing applications, due to this flexibility and fast reconfigurability. However, as previously discussed, ICs, such as FPGAs, that are implemented primarily using electrical components often experience limitations in computational speed and power efficiency. FPGAs that care constructed using traditional CMOS designs can be limited due to the low electronic clock rates and high Ohmic losses that are associated with electrical circuitry. FIG. 6 illustrates an example design to implement a programmable photonic FPGA 615, which is achievable by leveraging the memristor-integrated MZI device 610 that functions as a photonic device on the component level. In contrast to conventional electrical (or CMOS) FPGAs, the programmable photonic FPGA 615 is photonic-based. That is, the programmable photonic FPGA 615 is structured to increase the use of photonics in its design, and thus can realize ultra-wide bandwidth and ultra-fast computational speed with a low power consumption that is associated with photonic signal processing.

The programmable photonic FPGA 615 is illustrated as a photonic on-chip programmable signal processor, which comprises a grid of memristor-integrated MZI devices 610, as disclosed herein. The memristor-integrated MZI devices 610 function as photonic couplers, which are interconnected in a two-dimensional mesh network having an input fiber array 617 and an output fiber array 618. Additionally, FIG. 6 shows that the programmable photonic FPGA 615 can be packaged “on-chip” with an Application Specific Integrated Circuit (ASIC) or electronic control 620. Accordingly, the programmable photonic FPGA 615 has the capability to be programmed to implement various different circuit topologies and thereby can provide a diversity of signal processing functions for the computer device 630 while improving the overall processing efficiency for the computer device 620 through the use of photonics.

As alluded to above, there are a wide-range of applications in the realm of computer architecture that can be implemented by leveraging the distinct structure and function of the memristor-integrated MZI devices, as disclosed herein. One such application, is employing the disclosed memristor-integrated MZI devices to configure (and reconfigure) a programmable PIC. For example, the disclosed memristor-integrated MZI devices can be particularly manipulated to function as an optoelectronic non-volatile memory, in a manner that allows a program to be retained within the programmable PIC while the power to the circuit remains off. The memristor can hold the last state of the MZI without needing to leave the tuning arm biased, saving energy from idle power consumption while operating as a non-volatile memory.

Another application related to the disclosed memristor-integrated MZI devices includes utilizing the memristor of the memristor-integrated MZI device, as heaters in tuning MZIs to a specific wavelength. In this specific application, the memristor-integrated MZI device can be used to measure optical output without burning close to as much power or creating thermal crosstalk.

Moreover, a key advantage with respect to fabricating the disclosed memristor-integrated MZI device is the seamless integration of the memristor (and the entire structure of the memristor-integrated MZI device) into well-understood and developed fabrication processes on silicon. This further increases the ease of integration of these memristor-integrated MZI device into silicon photonics, such as PICs, photonic chips, photonic platforms (or photonic integration platforms), and the like. Thus, silicon photonics is another real-world and continuously emerging application related to the disclosed memristor-integrated MZI devices.

Yet another application related to the disclosed memristor-integrated devices includes leveraging the device's photonic interconnect functionalities to implement optical FPGAs. Realizing optical FPGAs can further enhance the power of programmable PICs, by integrated memory directly onto the same chip. In turn, the optical FPGAs application would be well-suited for implementing processing in specific types of processing applications, such as deep learning and artificial intelligence applications. For example, in a deep learning application, a neural network can train and learn by reconfiguring the memristors of the memristor-integrated MZI device, and then reading the outputs of meshes of memristor-integrated MZI devices.

Yet another application related to the disclosed memristor-integrated MZI devices includes non-volatile optical network routing switches. Network routers can switch data streams amongst different nodes in a network. The function of the network router is to receive the data package from one channel, store it, and send it to a second channel. Since the availability of the second channel is basically unknown, non-volatile memory may have to be used in the router. To this end, the optoelectronic non-volatile memory functionality of the disclosed memristor-integrated MZI devices can be leveraged to implement high-speed, non-volatile optical memory. The use of such a non-volatile optical memory (implemented using memristor-integrated MZI devices) can increase the operational speed of an optical network router and, subsequently, increase the overall speed of the Internet.

The memristor-integrated MZI device, disclosed herein, may emerge as a photonic device that aides in propelling technological advancements in silicon photonics, such as ultimately realizing an “all-optical” computer described above. An example of an “all-optical” computer system that could be potentially be developed would leverage several photonic/optical devices, including: optical interconnects (implemented using the disclosed memristor-integrated MZI device) for communicating/transferring information, optical logic gates for processing information, and optical memory elements (implemented using disclosed the memristor-integrated MZI device) for storing information.

Additional examples of applications for the memristor-integrated MZI device, in accordance with the disclosed embodiments, can include, but are not limited to: enabling a neuromorphic computer using large scale silicon photonic technology, which can be advantageous to electronics in its ability to create high-bandwidth, low-energy interconnects with minimal crosstalk; serving as the building block for implementing network meshes of photonic/optical memristor-integrated MZI devices to run matrix multiplication operations, which is the basis of modern day deep neural networks; implementing programmable silicon photonics; implementing metamorphic photonics; and implementing optical FPGAs. These applications are described for purposes of illustration and are not intended to be limiting, as other applications and advantages for the disclosed embodiments, not expressly disclosed herein, may become evident as technology in the realms of photonics, optics, and computer architecture continues to advance.

Due to the abundance of applications and advantages, as described herein, the disclosed memristor-integrated MZI device may develop into a photonic device that is a key building block in advancing silicon photonics and photonic applications.

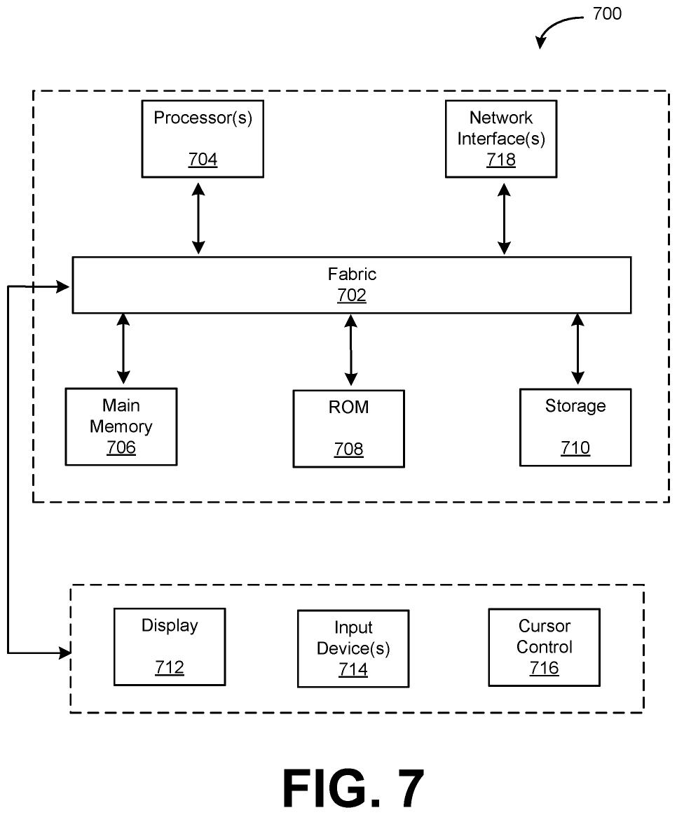

FIG. 7 depicts an example computer system 700 that can be utilized in relation to the memristor-integrated MZI device, as disclosed herein. The computer system 700 may utilize and/or include a photonic application that is implemented using the memristor-integrated MZI device of the embodiments. For example, the computer system 700 can be the system utilizing a programmable PIC, as illustrated in FIG. 6. By implementing a programmable PIC (e.g., leveraging the memristor-integrated MZI device) the computer system 700 may realize ultra-wide bandwidth and ultra-fast computational speed with a low power consumption that is associated with photonic signal processing in a manner that leads to the computer system 700 being well-suited for specific types of processing applications, such as deep learning and artificial intelligence applications. The computer system 700 includes a bus 702 or other communication mechanism for communicating information, one or more hardware processors 704 coupled with bus 702 for processing information. Hardware processor(s) 704 may be, for example, one or more general purpose microprocessors.

The computer system 700 also includes a main memory 806, such as a random-access memory (RAM), cache and/or other dynamic storage devices, coupled to bus 702 for storing information and instructions to be executed by processor 704. Main memory 706 also may be used for storing temporary variables or other intermediate information during execution of instructions to be executed by processor 704. Such instructions, when stored in storage media accessible to processor 704, render computer system 700 into a special-purpose machine that is customized to perform the operations specified in the instructions.

The computer system 700 further includes storage devices 710 such as a read only memory (ROM) or other static storage device coupled to fabric 702 for storing static information and instructions for processor 704. A storage device 710, such as a magnetic disk, optical disk, or USB thumb drive (Flash drive), etc., is provided and coupled to bus 702 for storing information and instructions.

The computer system 700 may be coupled via bus 702 to a display 712, such as a liquid crystal display (LCD) (or touch screen), for displaying information to a computer user. An input device 714, including alphanumeric and other keys, is coupled to bus 702 for communicating information and command selections to processor 704. Another type of user input device is cursor control 516, such as a mouse, a trackball, or cursor direction keys for communicating direction information and command selections to processor 704 and for controlling cursor movement on display 712. In some implementations, the same direction information and command selections as cursor control may be implemented via receiving touches on a touch screen without a cursor.

The computing system 700 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 700 may implement the techniques described herein using customized hard-wired logic, one or more ASICs or FPGAs, firmware and/or program logic which in combination with the computer system causes or programs computer system 700 to be a special-purpose machine. According to one embodiment, the techniques herein are performed by computer system 800 in response to processor(s) 704 executing one or more sequences of one or more instructions contained in main memory 706. Such instructions may be read into main memory 706 from another storage medium, such as storage device 710. Execution of the sequences of instructions contained in main memory 706 causes processor(s) 704 to perform the process steps described herein. In alternative implementations, hard-wired circuitry may be used in place of or in combination with software instructions.

As used herein, a circuit might be implemented utilizing any form of hardware, software, or a combination thereof. For example, one or more processors, controllers, ASICs, PLAs, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as computer system 700.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain implementations include, while other implementations do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A device, comprising:
Mach-Zehnder Interferometer (MZI) circuitry comprising two waveguides coupled to an output terminal, wherein the MZI circuitry produces an optical signal as output and propagates the output optical signal to the optical terminal; and
a memristor integrated on one of the two waveguides of the MZI circuitry, wherein the memristor receives an electrical signal as input and causes a phase shift in the output optical signal from the MZI circuitry.

2. The device of claim 1, wherein the two waveguides of the MZI circuitry are formed on a silicon layer.

3. The device of claim 2, wherein the memristor comprises a III-V layer, an oxide layer, formed on a portion of the silicon layer corresponding to one of the two waveguides of the MZI circuitry.

4. The device of claim 3, wherein the memristor is integrated on one of the two waveguides by heterogeneously integrating the III-V layer to the silicon layer.

5. The device of claim 1, wherein the electrical signal sets a resistive state of the memristor.

6. The device of claim 5, wherein the resistive state enables a storing of data in the memristor.

7. The device of claim 6, wherein the phase shift in the output optical signal from the MZI circuitry is measurable at the optical terminal.

8. The device of claim 7, wherein the measured phase shift in the output optical signal enables an optical reading of the data stored in the memristor.

9. The device of claim 8, wherein the optical reading enables at least one photonic device function comprising: an optical switching function, an optical memory function, and an optical interconnect function.

10. An integrated circuit comprising:
a silicon-on-insulator (SOI) wafer;
Mach-Zehnder Interferometer (MZI) circuitry formed on a silicon layer of the SOI wafer, wherein the MZI circuitry comprises waveguides to output an optical signal; and a
memristor formed on the silicon layer of the SOI wafer.

11. The integrated circuit of claim 10, wherein the memristor further comprises:
an oxide layer deposited on the silicon layer of the SOI wafer, wherein the oxide layer comprises an oxide/dielectric material; and
a III-V layer formed on the oxide layer, wherein the III-V layer is wafer bonded to the silicon layer of the SOI wafer via the oxide layer.

12. The integrated circuit of claim 11, wherein the oxide/dielectric material is selected based on at least one property of the oxide/dielectric material related to the wafer bonding.

13. The integrated circuit of the claim 12, wherein the at least one property of the oxide/dielectric material related to the wafer bonding comprises: bonding strength properties; capacitance properties; K dielectric properties; ionization properties; resistive switching properties; speed properties; durableness and/or high endurance properties; and optical properties.

14. The integrated circuit of claim 10, wherein wafer bonding the III-V layer to the silicon via the oxide layer forms an oxide bonding interface.

15. The integrated circuit of claim 14, comprising an n electrode layer formed on the III-V layer and a p electrode formed on the silicon layer to apply an electrical voltage across the oxide bonding interface.

16. The integrated circuit of claim 11, wherein applying an electric voltage across the oxide bonding interface sets a resistive state of the memristor.

17. The integrated circuit of claim 12, wherein the resistive state enables a storing of data in the memristor.

18. The integrated circuit of claim 17, wherein the resistive state causes a phase shift in the output optical signal

19. The integrated circuit of claim 18, wherein the phase shift in the output optical signal enables an optical reading of the data stored in the memristor.

20. The integrated circuit of claim 10, wherein the III-V layer is wafer bonded to a portion of the silicon layer corresponding to one of the waveguides of the MZI circuitry.
